(19) United States
(12) Patent Application Publication
(10) Pub. No.: US 2008/0180239 A1
(43) Pub. Date: Jul. 31, 2008

(54) Photo meter

(75) Inventor: Kai-Cheng Chan, Sinjhuang City (TW)

Correspondence Address: REED SMITH LLP, Suite 1400, 3110 Fairview Park Drive, Falls Church, VA, 22042, US

(73) Assignee: ICP Electronics Inc.

(21) Appl. No.: 11/898,277

(22) Filed: Sep. 11, 2007

(30) Foreign Application Priority Data
Jan. 31, 2007 (TW) 096201846

(51) Int. Cl. G08B 21/00

(52) U.S. Cl. 340/511

(57) ABSTRACT

The invention discloses a photo meter comprising a light emitting device, a photo sensor, and a controller. The controller has a look-up table, wherein the look-up table records a plurality of control signals and a plurality of standard lightness values. The controller is used for transmitting a plurality of control signals for controlling the light emitting device to generate a plurality of lightness. The photo sensor is used for sensing the lightness to generate a plurality of corresponding lightness values. Afterward, the controller receives the lightness values from the photo sensor and then broadcasts an alert signal to notify the user that the photo sensor should be replaced if the difference between each of the lightness values and each of the corresponding standard lightness values recorded in the look-up table is greater than a threshold value.

### BACKGROUND OF THE INVENTION

1. Field of the Invention

The invention relates to a photo meter and, more particularly, to a photo meter with self-checking function.

2. Description of the Prior Art

Please refer to FIG. 1. FIG. 1 is a functional block diagram illustrating a photo meter 1 of the prior art. As shown in FIG. 1, the photo meter 1 comprises a photo sensor 10, an analog-to-digital converter (ADC) 12, and a controller 14. The photo sensor 10 is used for sensing a plurality of lightness emitted from a light source (not shown), and then the photo meter 10 generates a plurality of corresponding lightness values. The ADC 12 is used for converting the lightness values (analog signals) into digital signals. The controller is used for receiving the lightness values converted by the ADC 12 to proceed.

In the prior art, once the photo sensor 10 gets aging or breaks down, the accuracy of measuring lightness will be influenced correspondingly. Currently, all of the conventional photo meters do not have self-checking function to notify the user that when the photo sensor 10 should be replaced.

Therefore, the scope of the invention is to provide a photo meter with self-checking function to solve the aforesaid problems.

### SUMMARY OF THE INVENTION

An object of the invention is to provide a photo meter with self-checking function. Once the photo sensor gets aging or breaks down, the photo meter of the invention will broadcast an alert signal to notify the user that the photo sensor should be replaced.

According to a preferable embodiment, the photo meter of the invention comprises a light emitting device, a photo sensor, and a controller. The controller has a look-up table, wherein the look-up table records a plurality of control signals and a plurality of standard lightness values corresponding to the standard lightness values.

The controller transmits a plurality of control signals to the light emitting device to control the light emitting device to generate a plurality of lightness. The photo sensor senses the lightness to generate a plurality of corresponding lightness values. Afterward, the controller receives the lightness values from the photo sensor and then broadcasts an alert signal to notify the user that the photo sensor should be replaced if a difference between each of the lightness values and each of the corresponding standard lightness values recorded in the look-up table is greater than a threshold value.

Therefore, according to the photo meter of the invention, once the photo sensor gets aging or breaks down, the lightness values sensed by the photo sensor will be different from the corresponding standard lightness values pre-established in the controller. When the difference exceeds tolerable error limit (e.g. the aforesaid threshold value), the photo meter of the invention will broadcast an alert signal to notify the user that the photo sensor should be replaced. It is extremely convenient for the user.

The advantage and spirit of the invention may be understood by the following recitations together with the appended drawings.

### BRIEF DESCRIPTION OF THE APPENDED DRAWINGS

FIG. 1 is a functional block diagram illustrating a photo meter of the prior art.

FIG. 2 is a functional block diagram illustrating a photo meter according to a preferable embodiment of the invention.

FIG. 3 is a schematic diagram illustrating the look-up table shown in FIG. 2.

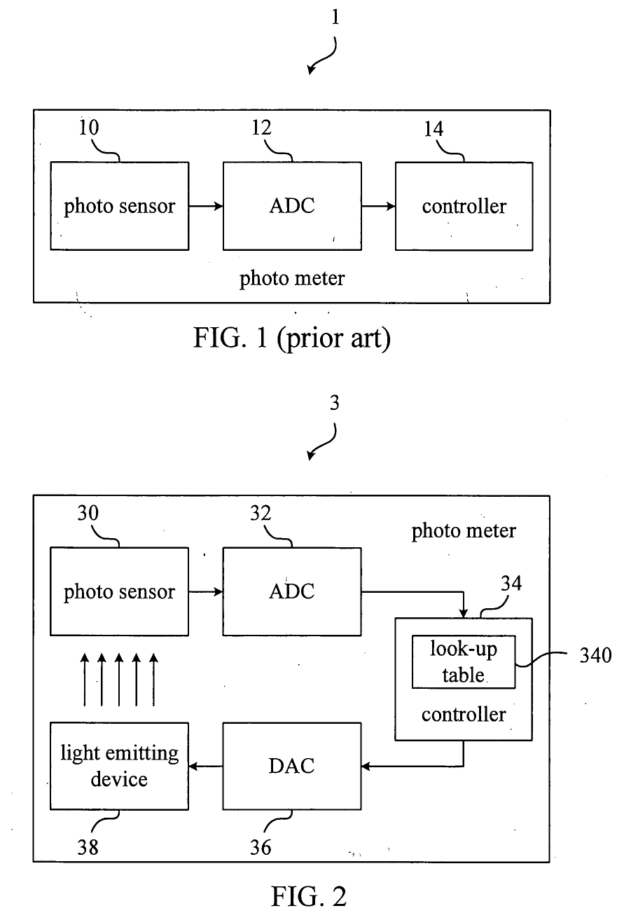

### DETAILED DESCRIPTION OF THE INVENTION

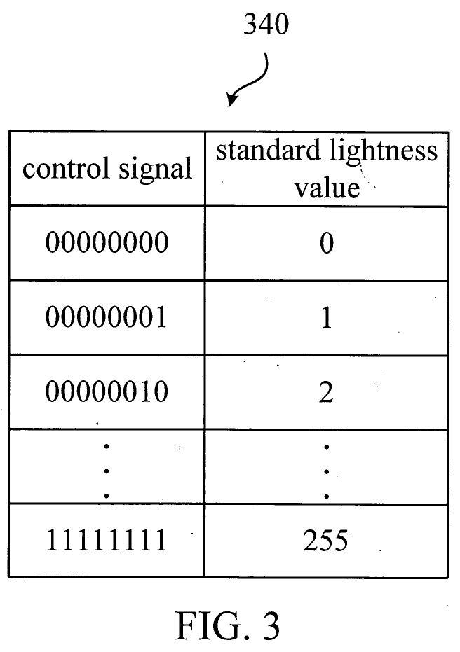

Please refer to FIG. 2 and FIG. 3. FIG. 2 is a functional block diagram illustrating a photo meter 3 according to a preferable embodiment of the invention. FIG. 3 is a schematic diagram illustrating the look-up table 340 shown in FIG. 2. As shown in FIG. 2, the photo meter 3 comprises a photo sensor 30, an analog-to-digital converter (ADC) 32, a control 34, a digital-to-analog converter (DAC) 36, and a light emitting device 38. The controller 34 has a look-up table 340. In this embodiment, the light emitting device 38 can be, but not limited to, a white light emitting diode. The ADC 32 is coupled between the photo sensor 30 and the controller 34, and the DAC 36 is coupled between the light emitting device 38 and the controller 34.

As shown in FIG. 3, the look-up table 340 records a plurality of control signals and a plurality of standard lightness values corresponding to the standard lightness values. For example, the control signal can be represented by 8 bits. If a control signal is represented as [0 0 0 0 0 0 1 0], the corresponding standard lightness value is equal to 2; if another control signal is represented as [1 1 1 1 1 1 1 1 1], the corresponding standard lightness value is equal to 255; and so on. In particular, the designer can determine that the control signal should be represented by how many bits based on practical applications.

In this embodiment, the controller 34 transmits a plurality of control signals to the light emitting device 38 to control the light emitting device 38 to generate a plurality of lightness. In particular, since the control signals transmitted by the controller 34 are digital signals, the control signals will be converted into analog signals by the DAC 36 and then transmitted to the light emitting device 38.

Afterward, the photo sensor 30 senses the lightness generated by the light emitting device 38 to generate a plurality of corresponding lightness values. The ADC 32 converts the lightness values (analog signals) generated by the photo sensor 30 into digital signals. After receiving the lightness values converted by the ADC 32, the controller 34 determines whether a difference between each of the lightness values and each of the corresponding standard lightness values recorded in the look-up table 340 is greater than a threshold value. If it is YES, the controller 34 broadcasts an alert signal to notify the user that the photo sensor 30 should be replaced. In particular, the threshold value can be determined by the designer based on practical applications.

For example, the threshold value is set as 5, the controller 34 transmits a control signal as [0 0 0 0 0 0 1 0] to control the light emitting device 38 to generate lightness, and the standard lightness value corresponding to [0 0 0 0 0 0 1 0] is equal to 2. If the lightness value generated by the photo sensor 30 is equal to 10, the difference between the lightness value and the corresponding standard lightness value is equal to 8. Since the difference exceeds the threshold value, the controller 34 will broadcast an alert signal. In other words, once the photo sensor 30 gets aging or breaks down, the photo meter 3 of the invention will broadcast the alert signal at once to notify the user that the photo sensor 30 should be replaced. Accordingly, the accuracy of lightness measured by the photo meter 3 can be ensured.

In this embodiment, the alert signal can be broadcasted in the form of at least one of audio, flash, video, text, and other manners.

Compared to the prior art, according to the photo meter of the invention, once the photo sensor gets aging or breaks down, the lightness values sensed by the photo sensor will be different from the corresponding standard lightness values pre-established in the controller. When the difference exceeds tolerable error limit (e.g. the aforesaid threshold), the photo meter of the invention will broadcast an alert signal to notify the user that the photo sensor should be replaced. It is extremely convenient for the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A photo meter comprising:
a light emitting device controlled by a plurality of control signals to generate a plurality of lightness;
a photo sensor for sensing a plurality of lightness to generate a plurality of corresponding lightness values; and
a controller having a look-up table, for transmitting the control signals to the light emitting device, receiving the lightness values from the photo sensor, and then broadcasting an alert signal if a difference between each of the lightness values and each of a plurality of corresponding standard lightness values recorded in the look-up table is greater than a threshold value.

2. The photo meter of claim 1, wherein the look-up table records the control signals and the standard lightness values respectively corresponding to the control signals.

3. The photo meter of claim 1, wherein the light emitting device is a white light emitting diode.

4. The photo meter of claim 1, further comprising an analog-to-digital converter (ADC), coupled between the photo sensor and the controller, for converting the lightness values transmitted from the photo sensor into digital signals.

5. The photo meter of claim 1, further comprising a digital-to-analog converter (DAC), coupled between the light emitting device and the controller, for converting the control signals transmitted from the controller into analog signals.

6. The photo meter of claim 1, wherein the alert signal is broadcasted in the form of at least one of audio, flash, video, and text.
